(19) United States
(12) Patent Application Publication
(10) Pub. No.: US 2009/0056682 A1
(43) Pub. Date: Mar. 5, 2009

(54) EGR cooler bypass switching system

(75) Inventors: Akira Okawa, Nisshin-shi (JP); Makoto Hatano, Nagoya-shi (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, OBU-SHI (JP)

(21) Appl. No.: 12/219,286

(22) Filed: Jul. 18, 2008

(30) Foreign Application Priority Data
Aug. 28, 2007 (JP) 2007-221018

(51) Int. Cl. F02M 25/07

(52) U.S. Cl. 123/568.12

(57) ABSTRACT

An EGR cooler bypass switching system integrally comprises an EGR cooler for cooling EGR gas and a switching valve for switching between introduction and non-introduction of the EGR gas with respect to the EGR cooler. The system further comprises a cooler core through which the EGR gas introduced in the EGR cooler passes; a cooler case housing the cooler core; a cooling water inlet pipe through which cooling water flows in the system; a cooling water outlet pipe which is provided in the cooler case and through which the cooling water flows out of the system; an in-cooler cooling water passage formed in the cooler case to allow the cooling water flowing therein through the cooling water inlet pipe to flow around an outer periphery of the cooler core; and an in-valve cooling water passage formed in a housing of the switching valve to allow the cooling water flowing therein from the cooling water inlet pipe to flow through for cooling the switching valve. The in-cooler cooling water passage and the in-valve cooling water passage communicate with each other at a mating face between the EGR cooler and the switching valve.

### BACKGROUND OF THE INVENTION

1. Field of the Invention

The present invention relates to an EGR cooler bypass switching system integrally including an EGR cooler for cooling EGR gas and a switching valve for switching between introduction and non-introduction (bypass) of EGR gas to the EGR cooler.

2. Description of Related Art

Heretofore, a diesel engine or the like has adopted an EGR (exhaust gas recirculation) system for reducing NOx in exhaust gas. In this EGR system, if high-temperature exhaust gas is circulated as it is to an intake side, the exhaust gas expanded due to high temperature will be supplied to an intake manifold. The ratio of exhaust gas in each cylinder is liable to increase. Accordingly, an amount of air in each cylinder decrease, deteriorating not only combustion efficiency but also exhaust gas components such as NOx.

Therefore, an EGR system equipped with EGR cooler has been developed, in which an EGR cooler for cooling exhaust gas (EGR gas) by heat exchange with cooling water is placed in a part of an EGR passage to recirculate high-temperature exhaust gas (EGR gas) to the intake manifold while cooling the exhaust gas by the EGR cooler. Meanwhile, this cooling of exhaust gas (EGR gas) may become excessive in the case where the temperature of the cooling water is low for example during engine start or during a cold period, which induces deterioration in combustion efficiency in each cylinder and exhaust gas components. Accordingly, the EGR system with EGR cooler is arranged to cause the exhaust gas (EGR gas) to flow in a bypass passage provided by diverting around a passage of the EGR cooler. For switching of this EGR cooler between during use and during nonuse, a passage switching valve is used to change a flow of exhaust gas from one way to two ways or a flow of exhaust gas from two ways to one way.

Such EGR system with EGR cooler is demanded to reduce mounting space thereof in an engine room. To eliminate the need for pipes for EGR cooler and bypass pipes for bypassing the EGR cooler, therefore, an EGR cooler bypass switching system integrally including an EGR cooler and a switching valve has been developed.

In the EGR cooler bypass switching system, however, the EGR cooler and the switching valve are formed with separate cooling-water passages as shown in FIG. 14. Thus, total four pipes are provided for inflow/outflow of cooling water. Respective pipes are connected to hoses or the like. In this way, the conventional EGR cooler bypass switching system would have problems in a large component count and poor vehicle mountability (mounting space and workability).

### BRIEF SUMMARY OF THE INVENTION

The present invention has been made in view of the above circumstances and has an object to provide an EGR cooler bypass switching system with a smaller component count and improved vehicle mountability.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided an EGR cooler bypass switching system integrally comprising an EGR cooler for cooling EGR gas and a switching valve for switching between introduction and non-introduction of the EGR gas with respect to the EGR cooler, the system further comprising: a cooler core through which the EGR gas introduced in the EGR cooler passes; a cooler case housing the cooler core; a cooling water inlet pipe through which cooling water flows in the system; a cooling water outlet pipe which is provided in the cooler case and through which the cooling water flows out of the system; an in-cooler cooling water passage formed in the cooler case to allow the cooling water flowing therein through the cooling water inlet pipe to flow around an outer periphery of the cooler core; and an in-valve cooling water passage formed in a housing of the switching valve to allow the cooling water flowing therein from the cooling water inlet pipe to flow through for cooling the switching valve; wherein the in-cooler cooling water passage and the in-valve cooling water passage communicate with each other at a mating face between the EGR cooler and the switching valve.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a sectional view showing a schematic configuration of an EGR cooler bypass switching system in a first embodiment;

FIG. 2 is a sectional view along a line II-II in FIG. 1;

FIG. 3 is a schematic configuration view of an actuator in a bypass valve;

FIG. 4 is a sectional view showing a schematic configuration of an EGR cooler bypass switching system in a second embodiment;

FIG. 5 is a sectional view showing a schematic configuration of an EGR cooler bypass switching system in a third embodiment;

FIG. 6 is a sectional view showing a schematic configuration of an EGR cooler bypass switching system in a fourth embodiment;

FIG. 7 is a sectional view along a line VII-VII in FIG. 6;

FIG. 8 is a sectional view showing a schematic configuration of another example of an EGR cooler bypass switching system in the fourth embodiment;

FIG. 9 is a sectional view showing a schematic configuration of an EGR cooler bypass switching system in a fifth embodiment;

FIG. 10 is a sectional view along a line X-X in FIG. 9;

FIG. 11 is a sectional view showing a schematic configuration of another example of an EGR cooler bypass switching system in the fifth embodiment;

FIG. 12 is a sectional view showing a schematic configuration of an EGR cooler bypass switching system in a sixth embodiment;

FIG. 13 is a sectional view showing a schematic configuration of another example of an EGR cooler bypass switching system in the sixth embodiment; and

FIG. 14 is a sectional view showing a schematic configuration of an EGR cooler bypass switching system in a related art.

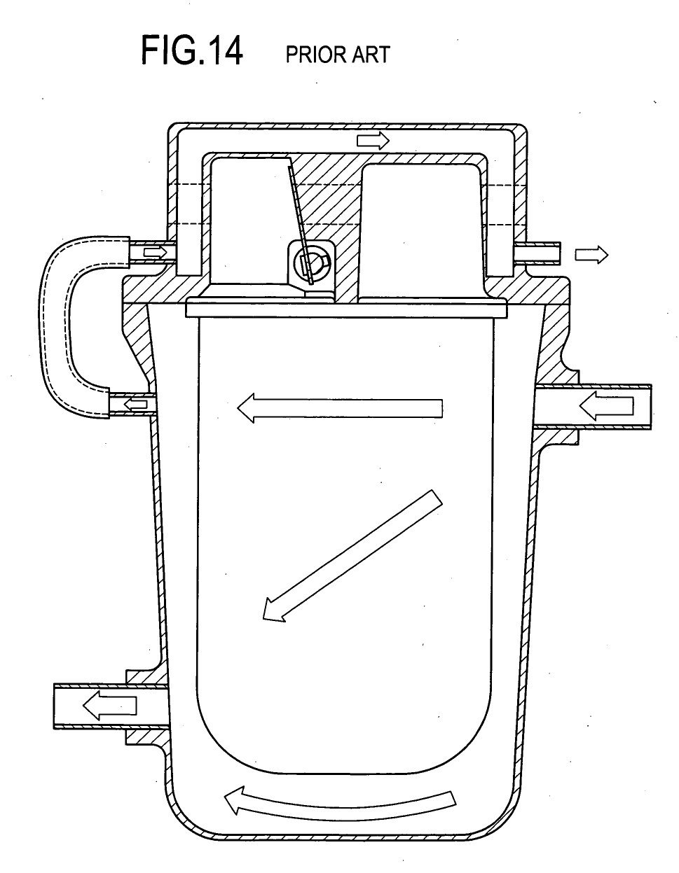

### DETAILED DESCRIPTION OF THE PREFERRED EMBODIMENTS

A detailed description of a preferred embodiment of an EGR cooler bypass switching system embodying the present invention will now be given referring to the accompanying drawings.

### First Embodiment

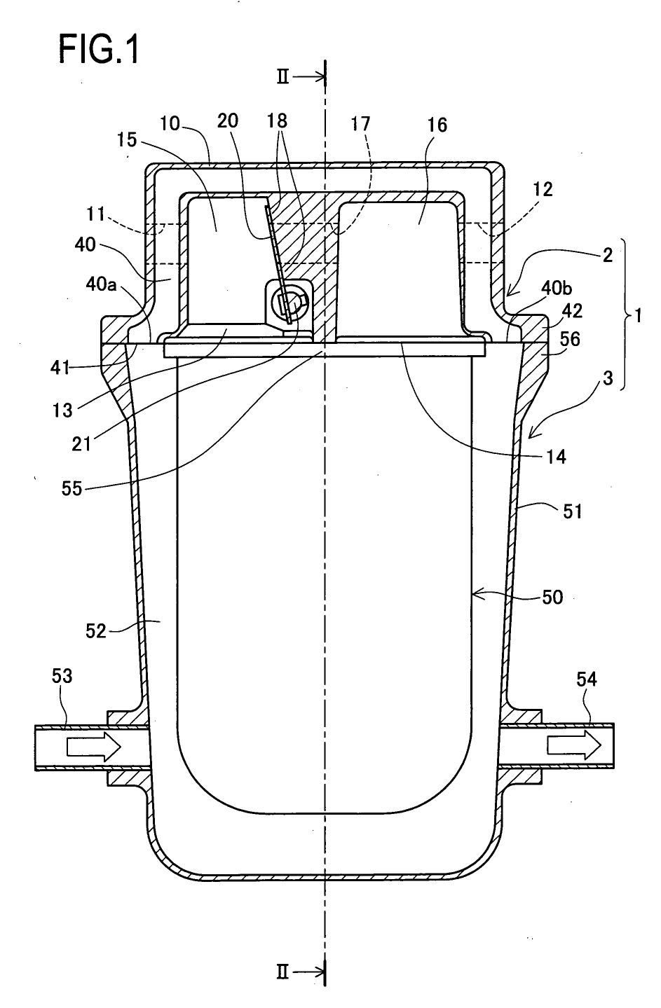

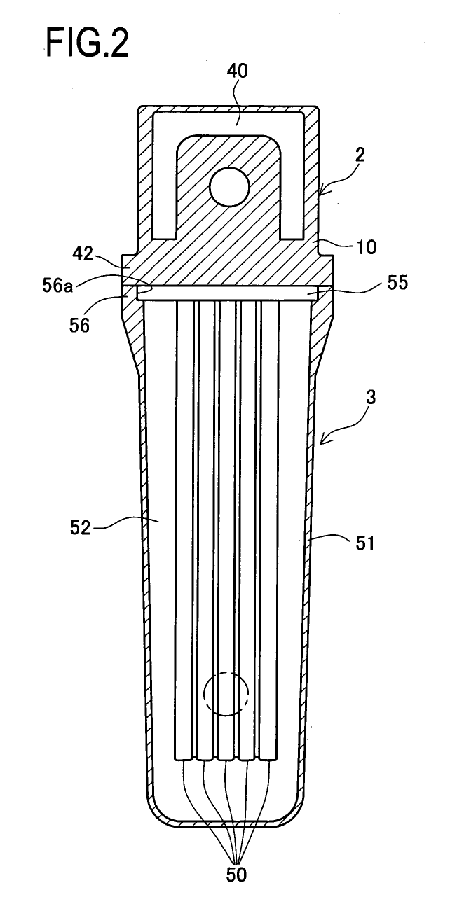

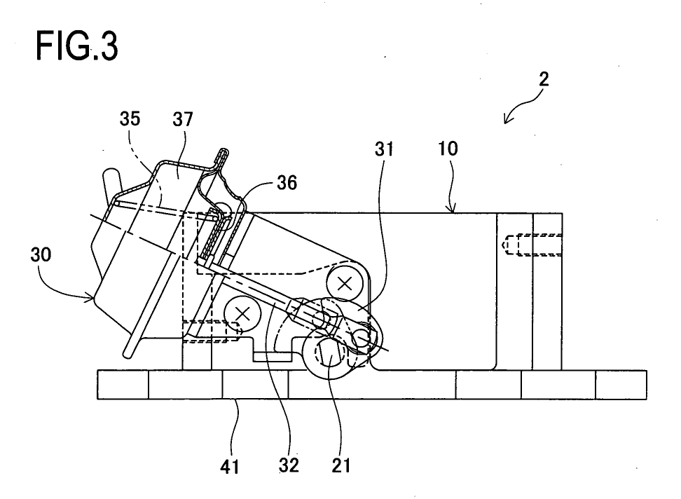

A first embodiment is first explained below. An EGR cooler bypass switching system in the first embodiment is described referring to FIGS. 1 to 3. FIG. 1 is a sectional view showing a schematic configuration of the EGR cooler bypass switching system in the first embodiment. FIG. 2 is a sectional view along a line II-II in FIG. 1. FIG. 3 is a schematic configuration view of an actuator in a bypass valve.

As shown in FIGS. 1 and 2, an EGR cooler bypass switching system 1 includes a bypass valve 2 and an EGR cooler 3. The EGR cooler 3 is directly attached to the bypass valve 2. Specifically, the bypass valve 2 and the EGR cooler 3 are integrally combined in one unit. Accordingly, the EGR cooler bypass switching system 1 needs no additional piping for connecting the bypass valve 2 and the EGR cooler 3. The bypass valve 2 and the EGR cooler 3 are connected with for example bolts.

Herein, the bypass valve 2 is a switching valve for switching between introduction and non-introduction (bypass) of EGR gas to the EGR cooler 3. This bypass valve 2 is provided as shown in FIG. 1 with a housing 10 formed with passages, a swing valve 20 for switching the passages formed in the housing 10, a valve shaft 21 attached thereon with the swing valve 20, and an actuator 30 (see FIG. 3) for rotating the valve shaft 21 to operate (swing) the swing valve 20.

The housing 10 is made of aluminum in a nearly rectangular parallelepiped shape. The housing 10 is formed with an inlet 11 for inflow of EGR gas, an outlet 12 for outflow of EGR gas (or EGR cooler gas), an introduction port 13 through which EGR gas flows in the EGR cooler 3, and a discharge port 14 through which EGR cooler gas having passed through the EGR cooler 3 flows out. The inlet 11 opens in one side face (a left side face in FIG. 1) of the housing 10. The outlet 12 opens in the other side face (a right side face in FIG. 1). The introduction port 13 and the discharge port 14 open in a mating face 41 of the housing 10 which contacts with the EGR cooler 3 (a lower face of the housing 10 in FIG. 1).

The housing 10 is further formed with a first passage 15 for providing communication between the inlet 11 and the introduction port 13, a second passage 16 for providing communication between the outlet 12 and the discharge port 14, and a bypass passage 17 for providing communication between the first passage 15 and the second passage 16. Those inlet 11, outlet 12, and bypass passage 17 are arranged in alignment.

Furthermore, the housing 10 is formed with an in-valve cooling water passage (hereinafter, referred to as an “in-valve passage”) 40 through which cooling water flows to cool the bypass valve 2. This in-valve passage 40 is formed with an entrance 40a and an exit 40b that open in the mating face 41 contacting with the EGR cooler 3. The entrance 40a and the exit 40b on the mating face 41 are connected respectively to an in-cooler cooling water passage (hereinafter, referred to as an “in-cooler passage”) 52 mentioned later. Specifically, the in-valve passage 40 communicates with the in-cooler passage 52 at the mating face 41. Accordingly, there is no need for piping such as hoses for connecting the in-valve passage 40 to the in-cooler passage 52.

The housing 10 is also provided with-a flange 42 with which the EGR cooler 3 is attached. This flange 42 is placed in contact with a flange 56 mentioned later of the EGR cooler 3 and then the bypass valve 2 and the EGR cooler 3 are fastened with bolts or the like into an integral unit.

The swing valve 20 is located in the first passage 15. An end of this swing valve 20 is fixed to the valve shaft 21. The swing valve 20 and the valve shaft 21 are made of a material (stainless steel in this embodiment) harder than a material of the housing 10. The swing valve 20 and the valve shaft 21 are applied with an oil repellent coating for preventing sticking of deposits thereto.

The valve shaft 21 is rotatably supported in the housing 10 with a bearing. One end portion of the valve shaft 21 protrudes out of the housing 10 and, as shown in FIG. 3, a link member 31 is attached to a distal end thereof. This link member 31 is coupled to a distal end of a rod 32 of the actuator 30.

Herein, the actuator 30 includes a diaphragm chamber 37 in which a diaphragm 36 is urged downward by a spring 35 (in a direction of pressing out the rod 32). The rod 32 is coupled to the diaphragm 36. In this actuator 30, when negative pressure is introduced in the diaphragm chamber 37, the diaphragm 36 is moved upward against the urging force of the spring 35, thereby retracting the rod 32 toward the actuator 30.

Upon activation of the actuator 30 (when negative pressure is introduced into the diaphragm chamber 37), pulling back the rod 32, the valve shaft 21 is rotated through the link member 31. As a result, the swing valve 20 fixed to the valve shaft 21 is swung or rotated for opening or closing operation. During operation of the actuator 30, the swing valve 20 is swung to extremely narrow a clearance between an outer edge of the swing valve 20 and an inner wall of the first passage 15, thus closing the introduction port 13.

During non-operation of the actuator 30, as shown in FIG. 1, the swing valve 20 is placed in contact with a valve seat 18 formed around an open end of the bypass passage 17 opening in the first passage 15. This valve seat 18 is formed at a slant relative to a horizontal direction so that a rotation angle of the swing valve 20 is less than 90 degrees. It is therefore possible to prevent deposits from sticking to the valve seat 18. Furthermore, the valve seat 18 is designed to allow surface contact with the swing valve 20. While the actuator 30 is not operated, accordingly, the swing valve 20 is placed in surface contact with the valve seat 18 to close the bypass passage 17.

The EGR cooler 3 serves to cool the EGR gas introduced by the bypass valve 2. The EGR cooler 3 is provided with a plurality of cooler cores 50 and a cooler case 51. The cooler cores 50 are housed in laminated form in the cooler case 51. In this embodiment, five cooler cores 50 are laminated to constitute a core.

Each cooler core 50 has a flat, nearly rectangular section, only one end of which is open, and is internally formed with an EGR passage through which EGR gas flows. Each cooler core 50 is fixed to a core plate 55 by a proximal end (on the open end side) passing therethrough. The cooler cores 50 are fixed to the cooler case 51 through the core plate 55.

The cooler case 51 has a flat, nearly rectangular section, only one end of which is open, and is internally provided with space in which the laminated cooler cores 50 are housed. The cooler case 51 is formed, around the open end thereof, with the flange 56 with which the cooler case 51 (the EGR cooler 3) is connected to the bypass valve 2. This flange 56 is formed, on its inner periphery, with a shoulder portion 56a in which the outer periphery portion of the core plate 55 is fitted and fixed as shown in FIG. 2.

The inside of the cooler case 51 provides a passage for allowing cooling water to flow through. In other words, in a state where the laminated cooler cores 50 are housed in the cooler case 51, the cooler case 51 and outer walls of the cooler cores 50 define the in-cooler passage 52. This passage 52 communicates with the in-valve passage 40 at the mating face 41.

Side walls (right and left side walls in FIG. 1) of the cooler case 51 are provided with a cooling water inlet pipe 53 through which cooling water flows into the system and a cooling water outlet pipe 54 through which the cooling water flow out of the system. The inlet pipe 53 is placed in a position near a distal end (a lower end in FIG. 1) of the cooler case 51 so as to introduce cooling water to the vicinity of distal ends (an opposite side from the open ends) of the cooler cores 50. The outlet pipe 54 is placed in a position of the cooler case 51 almost opposite from the inlet pipe 53. With this configuration, cooling water flowing in the system 1 through the inlet pipe 53 is discharged from the system 1 through the outlet pipe 54 by passing through the in-cooler passage 52 and the in-valve passage 40. As above, the EGR cooler bypass switching system 1 has only two ports for inflow/outflow of cooling water, namely, the inlet pipe 53 and the outlet pipe 54. Specifically, the number of cooling water inflow/outflow ports is reduced as compared with the conventional system.

The EGR cooler bypass switching system 1 configured as above is mounted midway on EGR piping placed between an exhaust manifold and an intake manifold of an engine. In other words, the inlet 11 of the EGR cooler bypass valve 2 is coupled to the exhaust manifold through the EGR piping and the outlet 12 is coupled to the intake manifold through the EGR piping.

At that time, as mentioned above, the EGR cooler bypass switching system 1 needs no piping such as hoses for connecting the in-cooler passage 52 and the in-valve passage 40, providing a reduced number of inflow/outflow ports for cooling water and a smaller component count of the system 1. This results in an entirely compact system only needing smaller mounting space. The reduction in inflow/outflow ports for cooling water also leads to a reduction in the number of piping works of hoses or the like. According to the EGR cooler bypass switching system 1, consequently, it is possible to achieve smaller mounting space and improved mounting workability, thus greatly enhancing vehicle mountability. Reduction in component count also leads to cost reduction.

Next, an explanation will be given to operations of the EGR cooler bypass switching system 1 constructed as above. In the case where the temperature of cooling water in the engine is a predetermined temperature or less (during a cold period), negative pressure is introduced in the diaphragm chamber 37 of the actuator 30 to activate the actuator 30. Then, the swing valve 20 is swung to open the bypass passage 17 and close the introduction port 13. In the first passage 15, accordingly, the inlet 11 and the bypass passage 17 are brought into communication with each other, whereas the inlet 11 and the introduction port 13 are out of communication with each other. EGR gas flowing from the EGR piping into the first passage 15 of the EGR cooler bypass valve 2 through the inlet 11 passes through the bypass passage 17 into the second passage 16. The EGR gas flowing in the second passage 16 flows out through the outlet 12 to be supplied to the intake manifold. During a cold period, as above, the EGR gas will be supplied as it is to the intake manifold without passing through the EGR cooler 3.

When the cooling water temperature rises to the predetermined temperature or higher (after warm-up), the introduction of negative pressure into the diaphragm chamber 37 of the actuator 30 is stopped. Then, the swing valve 20 is swung into surface contact with the valve seat 18 to close the bypass passage 17 and open the introduction port 13. In the first passage 15, accordingly, the inlet 11 and the bypass passage 17 are brought out of communication with each other, whereas the inlet 11 and the introduction port 13 are brought into communication with each other. Thus, EGR gas flowing from the EGR piping into the first passage 15 of the EGR cooler bypass valve 2 through the inlet 11 is supplied to the EGR cooler 3. The EGR gas cooled by the EGR cooler 3 then flows in the second passage 16 through the discharge port 14 and flows out the system 1 through the outlet 12 to be supplied to the intake manifold. After warm-up, in this way, the EGR gas cooled by the EGR cooler 3 is supplied to the intake manifold.

Herein, the cooling water inlet pipe 53 is provided in the cooler case 51 near its distal end (the lower end in FIG. 1) so as to introduce cooling water into the cooler case 51 from a position close to the distal ends (the opposite side from the open ends) of the cooler cores 50. The cooling water introduced in the cooler case 51 will impinge on the laminated cooler cores 50 and be divided into a flow directed toward the bypass valve 2 (upward in FIG. 1), a flow directed to the distal end of the cooler case 51 (downward in FIG. 1), and a flow directed around the outermost surfaces of the cooler cores 50. Because of those flows, the cooling water is allowed to flow all around the cooler cores 50 in the in-cooler passage 52. By the flow directed toward the bypass valve 2 (upward in FIG. 1), mainly, it is also possible to reliably supply the cooling water into the in-valve passage 40.

The cooling water supplied in the in-valve passage 40 flows out of the passage 40 through the exit 40b into the in-cooler passage 52 and merges with the cooling water flowing in the passage 52. This merging cooling water is discharged from the cooler case 51 through the outlet pipe 54 along with the cooling water having flowed in the in-cooler passage 52. Such flow of the cooling water in the in-cooler passage 52 and the in-valve passage 40 cools not only the EGR gas passing through the EGR cooler 3 but also the bypass valve 2.

According to the EGR cooler bypass switching system 1 in the first embodiment described in detail above, the in-cooler passage 52 and the in-valve passage 40 communicate with each other at the mating face 41 of the bypass valve 2 with respect to the EGR cooler 3. Therefore, the cooling water flowing in the system 1 through the inlet pipe 53 flows in the in-cooler passage 52 and the in-valve passage 40 and then flows out of the system 1 through the outlet pipe 54. This makes it possible to cool the EGR gas passing through the EGR cooler 3 and also cool the bypass valve 2.

The in-cooler passage 52 and the in-valve passage 40 directly communicate with each other and hence additional piping such as hoses is not needed for connecting those passages 52 and 40. The system 1 includes only the inlet pipe 53 and the outlet pipe 54 in total as the cooling water inflow/outflow ports. This smaller component count of the system allows downsizing of the entire system, providing reduced mounting space. The reduction in the number of inflow/outflow ports for cooling water also leads to a reduction in the number of piping works of hoses or the like. According to he EGR cooler bypass switching system 1, consequently, it is possible to achieve smaller mounting space and improved mounting workability, thus greatly enhancing vehicle mountability. Reduction in component count also leads to cost reduction.

### Second Embodiment

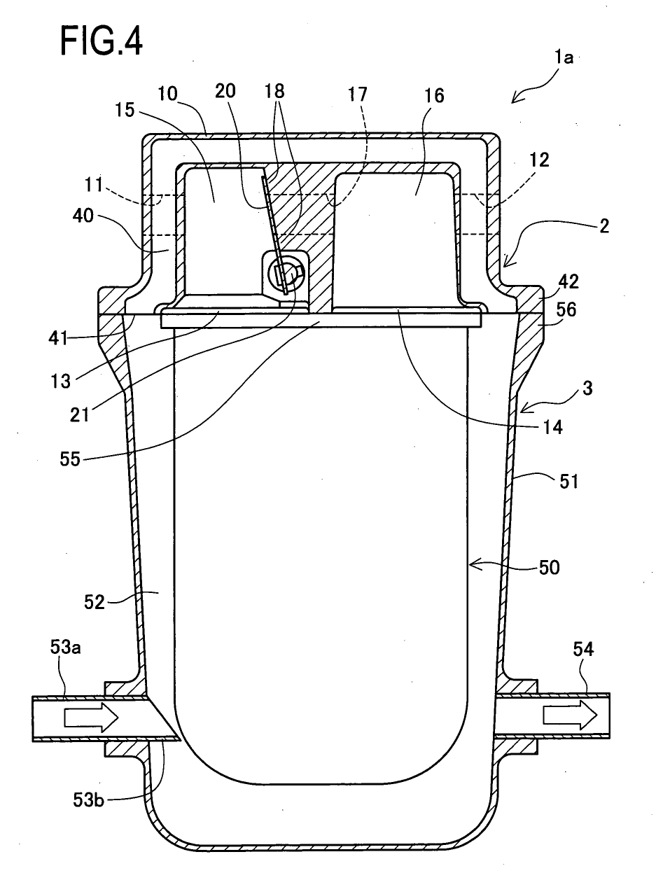

A second embodiment will be explained below. This embodiment is basically the same in configuration as the first embodiment except for the shape of an exit end of a cooling water inlet pipe. In this embodiment, therefore, similar parts or components to those in the first embodiment are assigned the same reference signs and their explanations will not be repeated. The following explanation will be made referring to FIG. 4 on an EGR cooler bypass switching system in the second embodiment with a focus on differences from that in the first embodiment. FIG. 4 is a sectional view showing a schematic configuration of the EGR cooler bypass switching system in the second embodiment.

As shown in FIG. 4, in an EGR cooler bypass switching system 1a, a cooling water inlet pipe 53a includes an exit end formed with a projection 53b protruding from the inner wall into the cooler case 51. This projection 53b is shaped to protrude, on a side (on a lower side in FIG. 4) of the exit opposite to a side closer to the bypass valve 2, from the inner wall into the cooler case 51.

The first embodiment provides a long passage length for causing the cooling water to flow from the inlet pipe 53, pass through the in-valve passage 40, and flow out of the system 1a through the outlet pipe 51. This may cause large pressure loss in the in-valve passage 40, resulting in a decrease in amount of cooling water in the in-valve passage 40. In other words, the amount of cooling water required for cooling the bypass valve 2 may not be supplied to the in-valve passage 40.

In the EGR cooler bypass switching system 1a in the second embodiment, on the other hand, the aforementioned projection 53b is provided at the exit end of the inlet pipe 53a. The cooling water that is introduced in the cooler case 51 and impinges on the laminated cooler cores 50 is divided into a flow directed toward the bypass valve 2 (upward in FIG. 4) and a flow directed around the outermost surfaces of the laminated cooler cores 50. In other words, a flow directed toward the distal end of the cooler case 51 (downward in FIG. 4) is not produced. Accordingly, the amount of cooling water directed toward the bypass valve 2 is increased (fast flow). This makes it possible to reliably supply the amount of cooling water required for cooling the bypass valve 2 from the in-cooler passage 52 to the in-valve passage 40.

The aforementioned EGR cooler bypass switching system 1a in the second embodiment can also supply a sufficient amount of cooling water to the in-valve passage 40 and provide the reduction in component count as in the first embodiment. Consequently, not only the reduction in component count but also enhancement in vehicle mountability can be achieved without deteriorating system cooling efficiency (cooling efficiency of the bypass valve 2 and the EGR cooler 3).

### Third Embodiment

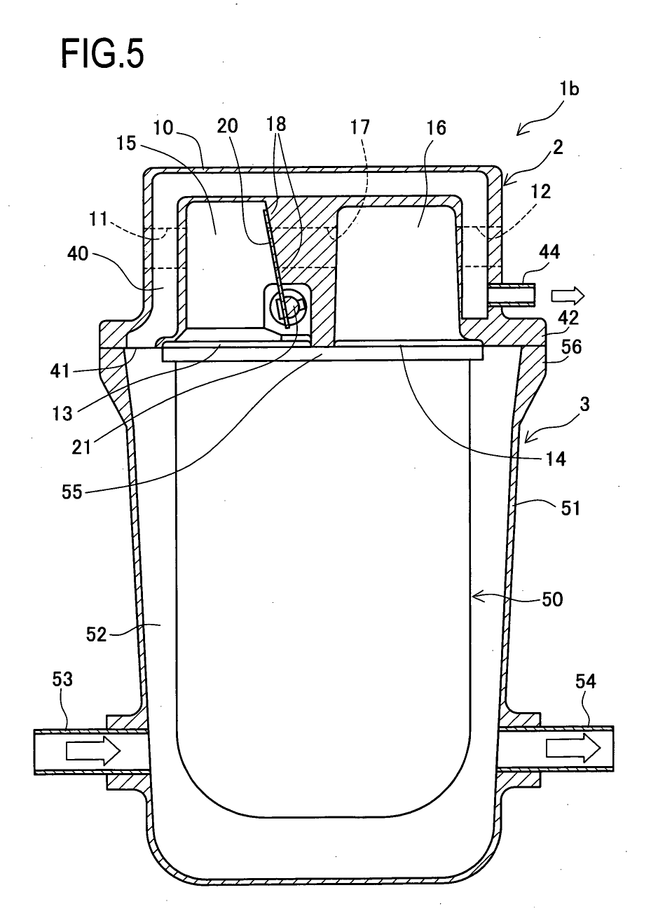

A third embodiment will be explained. This embodiment is basically the same in configuration as the first embodiment except for addition of a cooling water outlet pipe to the bypass valve. In this embodiment, therefore, similar parts or components to those in the first embodiment are assigned the same reference signs and their explanations will not be repeated. The following explanation will be made referring to FIG. 5 on an EGR cooler bypass switching system in the third embodiment with a focus on differences from that in the first embodiment. FIG. 5 is a sectional view showing a schematic configuration of the EGR cooler bypass switching sys in the third embodiment.

As shown in FIG. 5, an EGR cooler bypass switching system 1b includes an in-valve cooling water outlet pipe (hereinafter, referred to as a “valve outlet pipe”) 44 in the housing 10 of the bypass valve 2. This valve outlet pipe 44 is placed to communicate with a downstream side of the in-valve passage 40. The downstream side of the in-valve passage 40 (corresponding to the exit 40b) does not communicate with the in-cooler passage 52. With this configuration, the cooling water flowing in the in-valve passage 40 is discharged out of the system 1b through the valve outlet pipe 44.

This makes it possible to shorten the passage length for causing the cooling water introduced in the system 1b to pass through the in-valve passage 40 and flow out of the system 1b. Thus, the pressure loss in the in-valve passage 40 can be reduced. The amount of cooling water required for cooling the bypass valve 2 can therefore be supplied reliably from the in-cooler passage 52 to the in-valve passage 40.

It is preferable to design the valve outlet pipe 44 with such a diameter as to provide a ratio between a passage sectional area Svo of the valve outlet pipe 44 and a passage sectional area Sco of the outlet pipe 54 in a range of Sco:Svo=7:3 to 9:1. In this embodiment, the ratio of Sco:Svo is set to 8:2. This configuration can more reliably supply an amount of cooling water required for cooling the bypass valve 2 from the in-cooler passage 52 to the in-valve passage 40. This is because the ratio of less than 7:3 between the passage sectional area Sco and the passage sectional area Svo causes a cooling failure in the cooler cores 50 and reversely the ratio of more than 9:1 causes a cooling failure in the bypass valve 2.

The aforementioned EGR cooler bypass switching system 1b in the third embodiment can also supply a sufficient amount of cooling water to the passage 40 and provide the reduction in component count as in the first embodiment. Consequently, not only the reduction in component count but also enhancement in vehicle mountability can be achieved without deteriorating system cooling efficiency (cooling efficiency of the bypass valve 2 and the EGR cooler 3).

### Fourth Embodiment

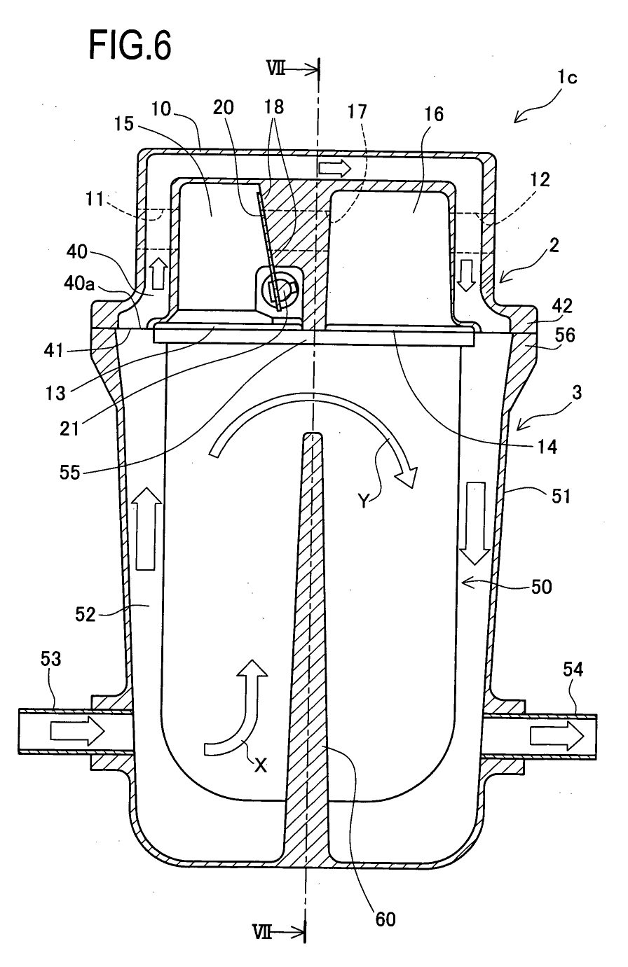

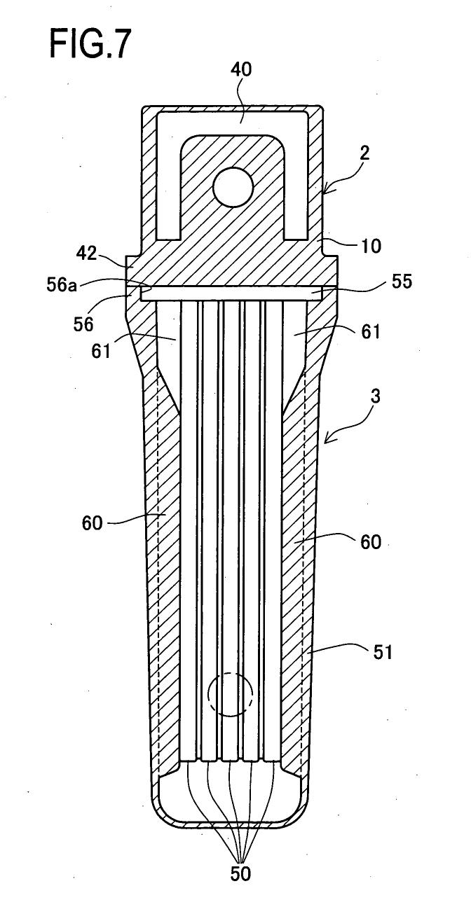

A fourth embodiment will be explained. This embodiment is basically the same in configuration as the first embodiment except for addition of a rib to the cooler case, which serves as a restriction member for restricting the flow of cooling water. In this embodiment, therefore, similar parts or components to those in the first embodiment are assigned the same reference signs and their explanations will not be repeated. The following explanation will be made referring to FIGS. 6 and 7 on an EGR cooler bypass switching system in the fourth embodiment with a focus on differences from that in the first embodiment. FIG. 6 is a sectional view showing a schematic configuration of the EGR cooler bypass switching system in the fourth embodiment. FIG. 7 is a sectional view along a line VII-VII in FIG. 6.

As shown in FIG. 6, in the EGR cooler bypass switching system 1c, the cooler case 51 is internally formed with ribs 60 on a center thereof. Each rib 60 vertically extends from the distal end toward the open end of the cooler case 51. Each rib 60 is in contact with the outermost one of the laminated cooler cores 50 as shown in FIG. 7 to hold the laminated cooler cores 50 from both sides. In a region including the ribs 60, the flow of cooling water in a direction (a lateral direction in FIG. 6) perpendicular to the longitudinal direction of the cooler cores 50 is restricted or reduced. Furthermore, the laminated cooler cores 50 are fixedly held by not only the core plate 55 but also the rib 60 and therefore the cooler cores 50 can be firmly fixed in place.

The cooling water introduced in the cooler case 51 will impinge on the laminated cooler cores 50 and be directed only toward the bypass valve 2 (upward in FIG. 6) in the region including the ribs 60. This is because the cooling water directed around the outermost surfaces of the laminated cooler cores 50 is directed to the proximal end of the cooler cores 50 as indicated by an arrow X in FIG. 6 by the ribs 60. In a region with no rib 60, the cooling water will be directed along a direction perpendicular to the longitudinal direction of the cooler cores 50 as indicated by an arrow Y in FIG. 6. With this configuration, the cooling water flowing from the inlet pipe 53 into the in-cooler passage 52 is allowed to flow toward the bypass valve 2, namely, toward the proximal end of the cooler cores 50.

Such ribs 60 can produce the flow of cooling water from the in-cooler passage 52 to the in-valve passage 40. Accordingly, it is possible to reliably supply an amount of cooling water required for cooling the bypass valve 2 from the in-cooler passage 52 to the in-valve passage 40.

It is preferable to design the rib 60 with such a length as to provide a ratio between a total sectional area Scr of passages 61 (see FIG. 7) defined by the ribs 60, the cooler cores 50 and core plate 55, and the cooler case 51 and a sectional area Svi of an entrance 40a of the in-valve passage 40 in a range of Scr:Svi=7:3 to 9:1. In this embodiment, the ratio of Scr:Svi is set to 8:2. With this configuration, it is possible to more reliably supply an amount of cooling water required for cooling the bypass valve 2 from the in-cooler passage 52 to the in-valve passage 40. This is because the ratio of less than 7:3 between the total sectional area Scr and the entrance sectional area Svi causes a cooling failure in the cooler cores 50 and reversely the ratio of more than 9:1 causes a cooling failure in the bypass valve 2.

The outlet pipe 54 is provided in the cooler case 51 near the distal ends of the cooler cores 50 and in approximately diametrically opposed position from the inlet pipe 53. The cooling water passing through the passages 61 is directed toward the distal ends of the cooler cores 50. In the in-cooler passage 52 with the ribs 60 serving as partition walls, accordingly, a flow of cooling water on a side closer to the inlet pipe 53 is directed from the distal ends to the proximal ends of the cooler cores 50 and a flow of cooling water on a side closer to the outlet pipe 54 is directed from the proximal ends to the distal ends of the cooler cores 50. This makes it possible to allow the cooling water to reliably flow around the entire cooler cores 50 in the in-cooler passage 52 and thus enhance the cooling efficiency of the EGR cooler 3.

The aforementioned EGR cooler bypass switching system 1c in the fourth embodiment can also supply a sufficient amount of cooling water to the in-valve passage 40 and provide the reduction in component count as in the first embodiment. Consequently, not only the reduction in component count but also enhancement in vehicle mountability can be achieved without deteriorating system cooling efficiency (cooling efficiency of the bypass valve 2 and the EGR cooler 3).

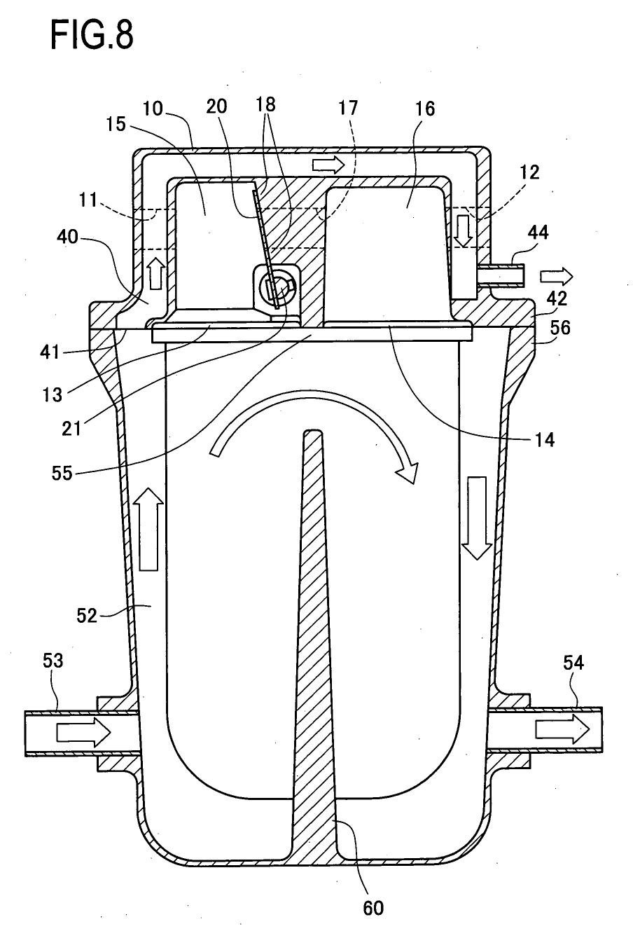

Herein, another example of the fourth embodiment may be combined with the configuration of the second embodiment. Specifically, the EGR cooler bypass switching system 1c in the fourth embodiment may be provided with a cooling water outlet pipe in the bypass valve. To be more concrete, as shown in FIG. 8, the valve outlet pipe 44 is provided in the housing 10 of the bypass valve 2 to communicate with a downstream side of the in-valve passage 40. The downstream side of the in-valve passage 40 (corresponding to the exit 40b) does not communicate with the in-cooler passage 52. With this configuration, the cooling water flowing in the in-valve passage 40 is discharged out of the system 1c through the valve outlet pipe 44.

This makes it possible to shorten the passage length for causing the cooling water introduced in the system 1c to pass through the in-valve passage 40 and flow out of the system 1c. Thus, the pressure loss in the in-valve passage 40 can be reduced. The amount of cooling water allowed to flow in the in-valve passage 40 can be increased, enhancing the cooling efficiency of the bypass valve 2.

### Fifth Embodiment

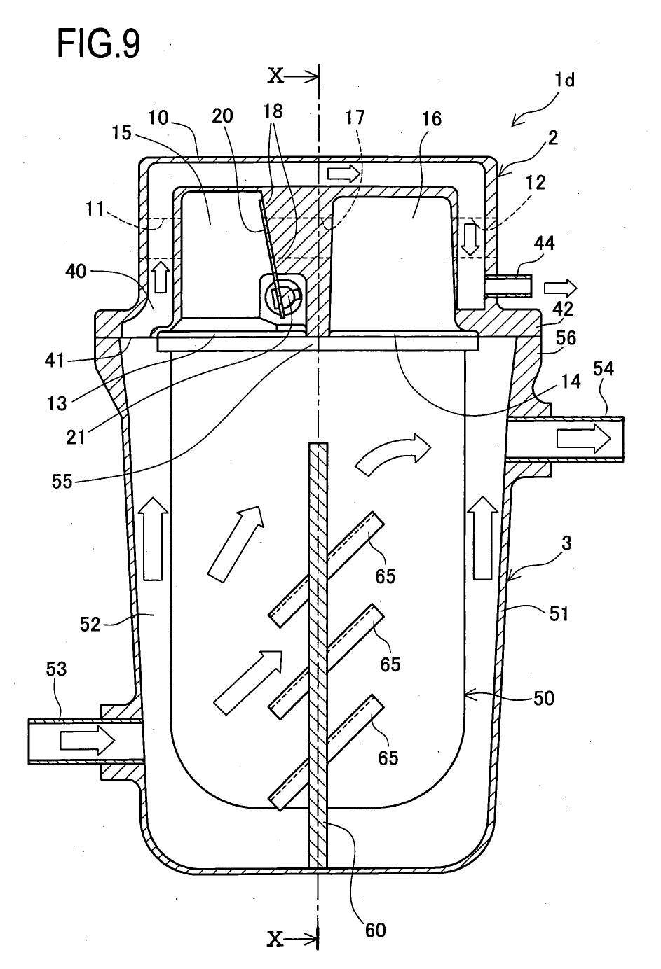

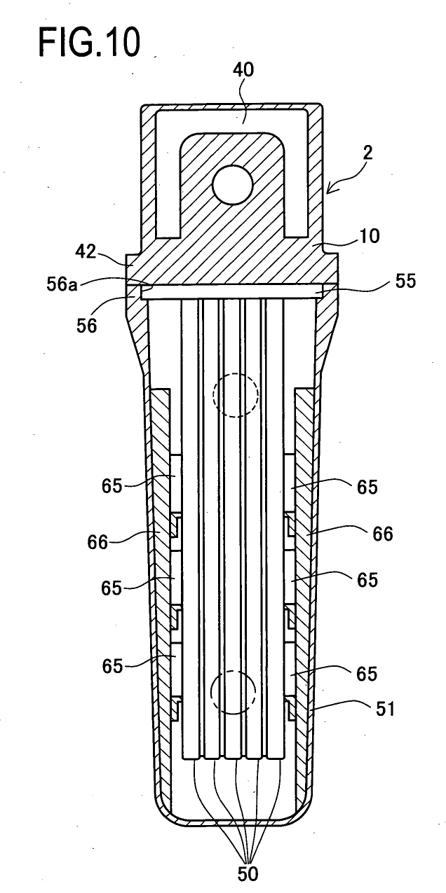

A fifth embodiment will be explained. This embodiment is basically the same in configuration as the second embodiment except for addition of fins in the in-cooler passage, which serve as a guide member for guiding the cooling water to the proximal ends of the cooler cores 50. In this embodiment, therefore, similar parts or components to those in the second embodiment are assigned the same reference signs and their explanations will not be repeated. The following explanation will be made referring to FIGS. 9 and 10 on an EGR cooler bypass switching system in the fifth embodiment with a focus on differences from that in the second embodiment. FIG. 9 is a sectional view showing a schematic configuration of the EGR cooler bypass switching system of the fifth embodiment. FIG. 10 is a sectional view along a line X-X in FIG. 9.

In the EGR cooler bypass switching system id, as shown in FIG. 9, fins 65 are arranged at the center in a width (lateral in the figure) direction of the cooler case 51. In this embodiment, three on either side, that is, total six fins 65 are arranged (see FIG. 10). Each fin 65 is located in a region between the distal end (the bottom) and about the center in the longitudinal direction of the cooler case 51. Each fin 65 is attached to a stay 66 and attached to the cooler core 50 or the cooler case 51. The attached fins 65 are in contact with the outermost ones of the laminated cooler cores 50 to fixedly hold the laminated cooler cores 50 from both sides as shown in FIG. 10. In other words, the fins 65 also serve to hold and fix the cooler cores 50. Accordingly, the laminated cooler cores 50 are fixedly held not only by the core plate 55 but also by the fins 65, so that the cooler cores 50 can be firmly fixed in place.

The cooling water introduced in the cooler case 51 will impinge on the laminated cooler cores 50 and be divided into a flow directed toward the bypass valve 2 (upward in FIG. 9), a flow directed toward the distal end (the bottom) of the cooler case 51 (downward in FIG. 9), and a flow directed around the outermost surfaces of the laminated cooler cores 50. The flow directed around the outermost surfaces of the laminated cooler cores 50 will be changed to a flow directed toward the bypass valve 2 (upward in FIG. 9) by the fins 65. In other words, the cooling water going around the outermost surfaces of the laminated cooler cores 50 is guided toward the proximal ends of the cooler cores 50. The cooling water guided to the proximal ends of the cooler cores 50 is then allowed to flow out of the system id through the outlet pipe 54 formed in the cooler case 51 at a position close to an open end thereof Simultaneously, a part of the cooling water will flow in the in-valve passage 40.

Such fins 65 allow production of the flow of cooling water from the in-cooler passage 52 to the in-valve passage 40. Accordingly, it is possible to reliably supply and flow an amount of cooling water required for cooling the bypass valve 2 from the in-cooler passage 52 to the in-valve passage 40.

The aforementioned EGR cooler bypass switching system id in the fifth embodiment can also supply a sufficient amount of cooling water to the passage 40 and provide the reduction in component count as in the first embodiment. Consequently, not only the reduction in component count but also enhancement in vehicle mountability can be achieved without deteriorating system cooling efficiency (cooling efficiency of the bypass valve 2 and the EGR cooler 3).

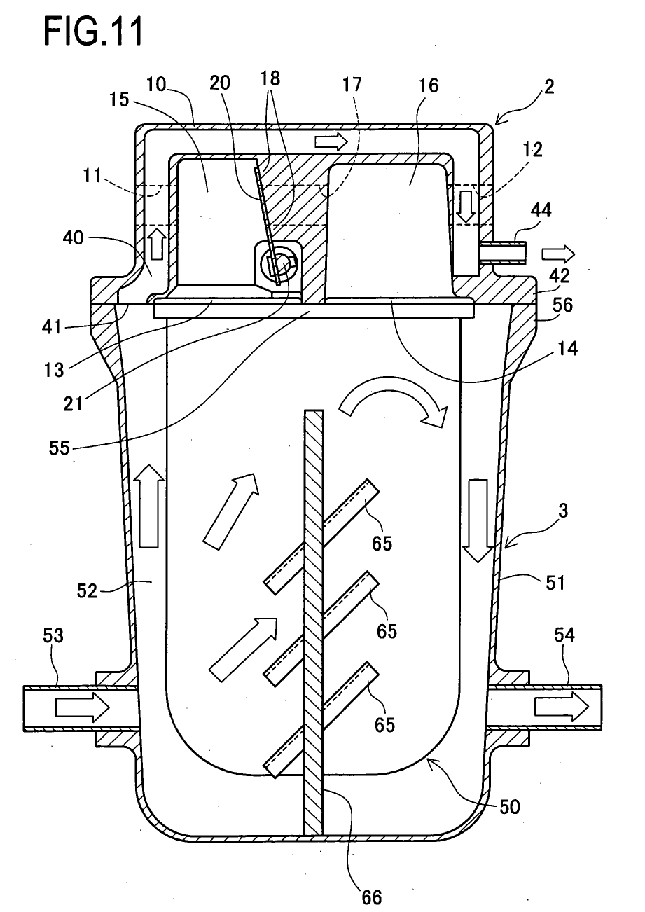

Herein, as another example of the fifth embodiment, the outlet pipe 54 may be provided in the cooler case 51 at a position close to the distal end thereof as shown in FIG. 11. With this configuration, the pressure loss in the in-cooler passage 52 will increase. The amount of cooling water allowed to flow from the in-cooler passage 52 to the in-valve passage 40 can be increased. Consequently, the amount of cooling water allowed to flow in the in-valve passage 40 can be increased, enhancing the cooling efficiency of the bypass valve 2.

### Sixth Embodiment

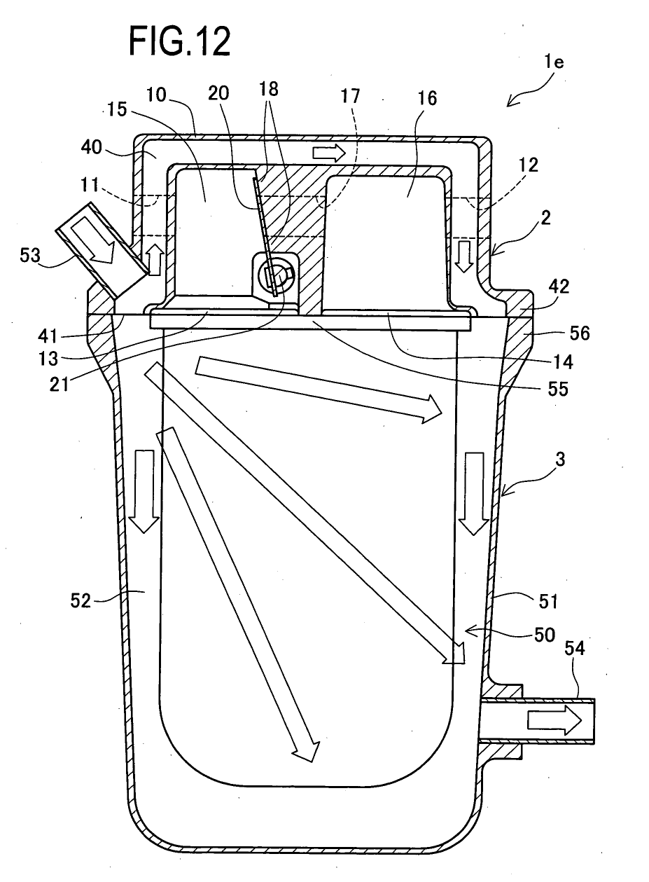

Finally, a sixth embodiment will be explained. This embodiment is basically the same in configuration as the first embodiment except that the cooling water inlet pipe is provided in the housing of the bypass valve, not in the cooler case. In this embodiment, therefore, similar parts or components to those in the first embodiment are assigned the same reference signs and their explanations will not be repeated. The following explanation will be made referring to FIG. 12 on an EGR cooler bypass switching system in the sixth embodiment with a focus on differences from that in the first embodiment. FIG. 12 is a sectional view showing a schematic configuration of the EGR cooler bypass switching system of the sixth embodiment.

In the EGR cooler bypass switching system 1e, as shown in FIG. 12, the inlet pipe 53 is attached obliquely to the housing 10 of the bypass valve 2. This inlet pipe 53 communicates with an upstream side of the in-valve passage 40 (near the mating face 41). Accordingly, the cooling water is directly supplied from the inlet pipe 53 into the in-valve passage 40 and hence an amount of cooling water required for cooling the bypass valve 2 is allowed to flow in the in-valve passage 40.

Furthermore, the inlet pipe 53 is placed on the upstream side of the in-valve passage 40 and in a downward slanting position toward the EGR cooler 3. Even where the inlet pipe 53 is attached to the housing 10, a sufficient amount of cooling water is allowed to flow in the in-cooler passage 52. Thus, the cooling efficiency of the EGR cooler 3 will not decrease.

The aforementioned EGR cooler bypass switching system 1e in the sixth embodiment can also directly supply the cooling water from the inlet pipe 53 to the in-valve passage 40. Thus, a sufficient amount of cooling water is allowed to flow in the in-valve passage 40. In addition, the inlet pipe 53 is placed on the upstream side of the in-valve passage 40 and in the downward slanting position toward the EGR cooler 3 and therefore a sufficient amount of cooling water is also allowed to flow in the in-cooler passage 52. Furthermore, the reduction in component count can be provided as in the first embodiment. Consequently, not only the reduction in component count but also enhancement in vehicle mountability can be achieved without deteriorating system cooling efficiency (cooling efficiency of the bypass valve 2 and the EGR cooler 3).

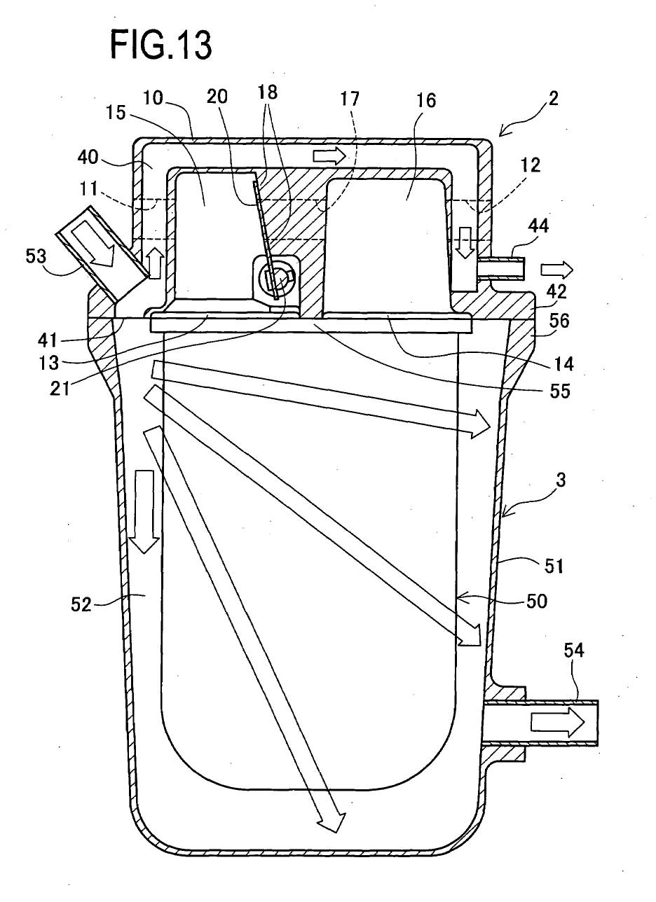

Herein, another example of the sixth embodiment may be combined with the configuration of the second embodiment. Specifically, the EGR cooler bypass switching system in the sixth embodiment may be provided with a cooling water outlet pipe in the bypass valve 2. To be more concrete, as shown in FIG. 13, the valve outlet pipe 44 is provided in the housing 10 of the bypass valve 2 to communicate with a downstream side of the in-valve passage 40. The downstream side of the in-valve passage 40 (corresponding to the exit 40b) does not communicate with the in-cooler passage 52. With this configuration, the cooling water flowing in the in-valve passage 40 is fully discharged out of the system 1e through the valve outlet pipe 44.

This makes it possible to shorten the passage length for causing the cooling water introduced in the in-valve passage 40 to flow out of the system 1e. Thus, the pressure loss in the in-valve passage 40 can be reduced. The amount of cooling water allowed to flow in the in-valve passage 40 can therefore be increased, thereby enhancing the cooling efficiency of the bypass valve 2.

The aforementioned embodiments are mere examples not to be limitative of the scope of the invention. The present invention may be embodied in other specific forms without departing from the essential characteristics thereof. For instance, although the fourth embodiment exemplifies the ribs 60 provided (integrally formed) in the cooler case 51, the ribs 60 may be formed as separate parts from the cooler case 51.

As an alternative to the fins 65 fixed to the stays 66 in the fifth embodiment, the fins 65 may be fixed (or integrally formed) to the cooler cores 50 or the cooler case 51 without use of the stay.

Furthermore, the aforementioned configurations may be combined arbitrarily. Such combinations will provide multiplier effects.

What is claimed is:

1. An EGR cooler bypass switching system integrally comprising an EGR cooler for cooling EGR gas and a switching valve for switching between introduction and non-introduction of the EGR gas with respect to the EGR cooler, the system further comprising:
a cooler core through which the EGR gas introduced in the EGR cooler passes;
a cooler case housing the cooler core;
a cooling water inlet pipe through which cooling water flows in the system;
a cooling water outlet pipe which is provided in the cooler case and through which the cooling water flows out of the system;
an in-cooler cooling water passage formed in the cooler case to allow the cooling water flowing therein through the cooling water inlet pipe to flow around an outer periphery of the cooler core; and
an in-valve cooling water passage formed in a housing of the switching valve to allow the cooling water flowing therein from the cooling water inlet pipe to flow through for cooling the switching valve;
wherein the in-cooler cooling water passage and the in-valve cooling water passage communicate with each other at a mating face between the EGR cooler and the switching valve.

2. The EGR cooler bypass switching system according to claim 1, wherein
the cooling water inlet pipe is provided in the cooler case near an end thereof opposite from the other end connected with the switching valve to allow the cooling water to flow in the system in the vicinity of a distal end of the cooler core.

3. The EGR cooler bypass switching system according to claim 1, further comprising a restriction member placed in the in-cooler cooling water passage and arranged to fixedly hold the cooler core and restrict a flow of the cooling water flowing in the in-cooler cooling water passage through the cooling water inlet pipe,
wherein the restriction member is adapted to restrict a flow of cooling water in a direction perpendicular to a longitudinal direction of the cooler core in the distal end of the cooler core.

4. The EGR cooler bypass switching system according to claim 3, wherein
the restriction member is provided extending from a distal end of the cooler case to a position closer to the switching valve than a center of the cooler case in a longitudinal direction thereof.

5. The EGR cooler bypass switching system according to claim 3, wherein
the restriction member is formed integral with one of the cooler case and the cooler core.

6. The EGR cooler bypass switching system according to claim 3, wherein
the restriction member, the cooler core, and the cooler case define a cooling water passage around a proximal end of the cooler core so that a ratio between a sectional area of the cooling water passage and a sectional area of an entrance of the in-valve cooling water passage are determined in a range of 7:3 to 9:1.

7. The EGR cooler bypass switching system according to claim 3, wherein
the cooling water outlet pipe is provided in the cooler case in an opposite position from the cooling water inlet pipe to allow the cooling water to flow out of the system from the distal end of the cooler core.

8. The EGR cooler bypass switching system according to claim 1, further comprising a guide member placed in the in-cooler cooling water passage and adapted to fixedly hold the cooler core and guide the cooling water flowing in the in-cooler cooling water passage through the cooling water inlet pipe to flow toward a proximal end of the cooler core.

9. The EGR cooler bypass switching system according to claim 8, wherein
the guide member is arranged in a region between a distal end and a center of the cooler case in a longitudinal direction thereof.

10. The EGR cooler bypass switching system according to claim 1, further comprising a valve cooling water outlet pipe provided in a housing of the switching valve and adapted to allow the cooling water to flow out of the system from a downstream side of the in-valve cooling water passage.

11. The EGR cooler bypass switching system according to claim 10, wherein
a ratio between a sectional area of the cooling water outlet pipe and a sectional area of the valve cooling water outlet pipe is determined in a range of 7:3 to 9:1.

12. The EGR cooler bypass switching system according to claim 2, wherein
the cooling water inlet pipe includes an exit end formed with a projection further protruding than an inner surface of the cooler case on a side of the exit opposite to a side closer to the switching valve.

13. The EGR cooler bypass switching system according to claim 1, wherein
the cooling water inlet pipe is provided in a housing of the switching valve to allow the cooling water to flow from an upstream side of the in-valve cooling water passage.

14. The EGR cooler bypass switching system according to claim 13, wherein
the cooling water inlet pipe is placed in the housing of the switching valve and in a slanting position toward the EGR cooler.
